(19) United States
(12) Patent Application Publication
(10) Pub. No.: US 2014/0299828 A1
(43) Pub. Date: Oct. 9, 2014

(54) Threadless Fairlead

(71) Applicant: Vincent Brenner, South Haven, MI (US)

(72) Inventor: Vincent Brenner, South Haven, MI (US)

(21) Appl. No.: 13/857,116

(22) Filed: Apr. 4, 2013

(51) Int. Cl. B66D 1/36

(52) U.S. Cl. CPC B66D 1/36
USPC 254/389

(57) ABSTRACT

A threadless fairlead assembly for a sailing vessel is provided, in which the C-shaped fairlead body has a channel which passes from the outside of the body to the aperature and is closed by a latch pin, this configuration allows a line to pass in and out of the assembly while remaining relatively parallel to the centerline of the aperature.

### BACKGROUND OF THE INVENTION

In general, a “fairlead” is a device used on marine vessels to lead and position ropes, lines or running rigging; for example, on a sailing vessel, the lines which are used to control the position and shape of a sail. Fairleads are employed to prevent extraneous binding, friction, and/or chafe on the lines or running rigging.

A conventional fairlead generally comprises of a closed block which is mounted to a surface, the block has a through aperture passing perpendicular to the main face of the block which is used to capture the line. In order to capture a line with a conventional fairlead, the free end of the rope must be threaded and drawn through the block's aperture. “Threadless” fairleads are generally of an open configuration; the body not only has the through aperture but also has a channel which is set with its axis at an angle to the main axis of the aperture. The channel creates a free gap from the outside of the block to the inside aperture and allows for the release or capture of the line at any point along its length. As the channel is set at an angle to the main aperture, the line must be skewed to match this axis in order for the member to pass through the channel and locate in the aperture or of the reverse. After the line passes through the channel and enters the aperture, it then can assume the center line of the aperture to work within the fairlead body. This engagement or disengagement of the line via skewing can be particularly challenging and time consuming when the line is under tension or load.

One type of threadless fairlead currently available in the market is shown in U.S. Pat. No. D564,342 and is shown as prior art in FIG. 2. Generally, the design incorporates a base 80 with two inverted, “j” shaped hooks 93 with each one of their respective ends affixed at locations on the base 80; the hooks are bent, parallel and the free ends point to each other; the curvature of the hooks are aligned to form an aperture. The hooks are offset and have a projected channel between them; wherein a rope would be skewed for insertion or extraction relative to the aperture.

### SUMMARY OF THE INVENTION

The present invention provides a threadless fairlead, with the fairlead having improvements to allow for the expeditious engagement or disengagement of the line relative to the device, without having to skew the line in situations where the line is under tension or load.

The assembly of the present invention comprises of an open main body with aperture and a traversing latch pin with pull to provide closure. The fairlead main body is C-shaped which affords a rigid, fixed position for the aperture; the channel runs parallel to the base and opens to one side of the body. The channel and aperture have a width which is slightly larger than the largest diameter line that the fairlead can accept. A traversing latch pin moves vertically within a cavity in the body, the centerline of which is offset from the center of the aperture and runs perpendicular to it. This latch pin so provides the means to close and open the aperture. The latch pin seats in a cavity in the bottom of the channel at closure of the aperture. A pull pin extends from the latch pin and exits through the top of the body. The pull is secured to the latch pin and moves directly in relation, thus providing the means to actuate the mechanism. The latch pin may be spring loaded to force the channel to close but may also be free or magnetically latched.

The composition of the threadless fairlead greatly improves the functionality of the assembly in comparison with the prior art, especially in terms of allowing the sailor to easily couple or release the line and fairlead without the need to skew the line in situations where the line is under tension or load. Also, the method for release allows for the actuation to occur more expeditiously than with prior art constraints and in comparison with conventional fairleads, allows for the line to be released at any point along its length. The design may have dimensions which are scaled to provide use with different sizes or types of lines.

### BRIEF DESCRIPTION OF THE DRAWINGS

FIG. 1 is an isometric view showing the threadless fairlead assembly of the present invention with latch pin in closed position.

FIG. 2 is an isometric view showing the prior art threadless fairlead.

FIG. 3 is a top view of the threadless fairlead assembly of the present invention with section line in parallel to the main face of the body and located in the middle of the body.

FIG. 4 is a section view of the assembly with section plane established in FIG. 3. The latch pin is shown in the closed position.

FIG. 5 is a isometric view showing the threadless fairlead assembly of the present invention with latch pin in closed position.

### DETAILED DESCRIPTION

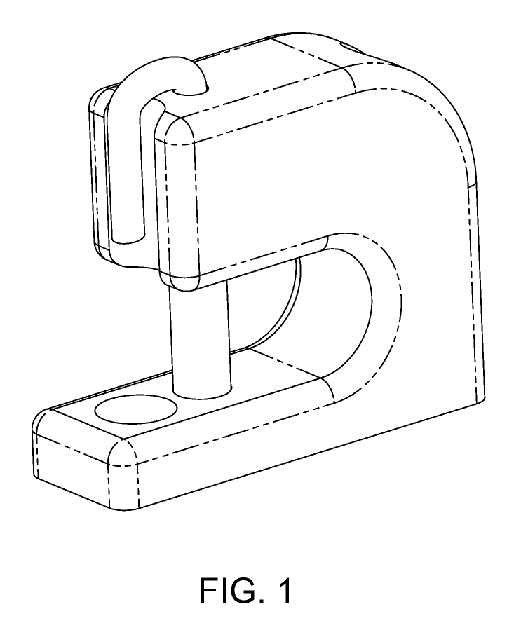

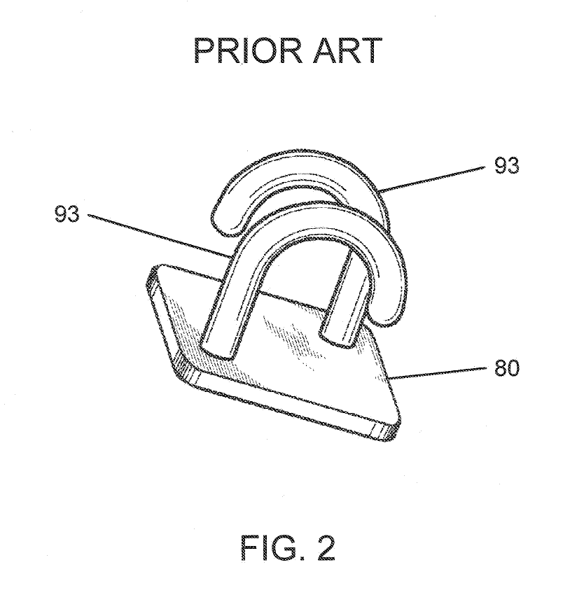

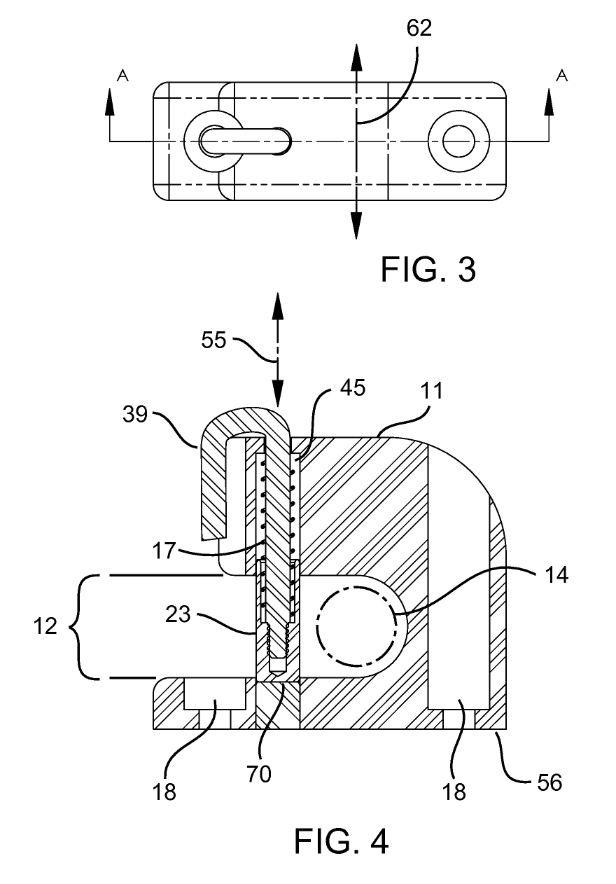

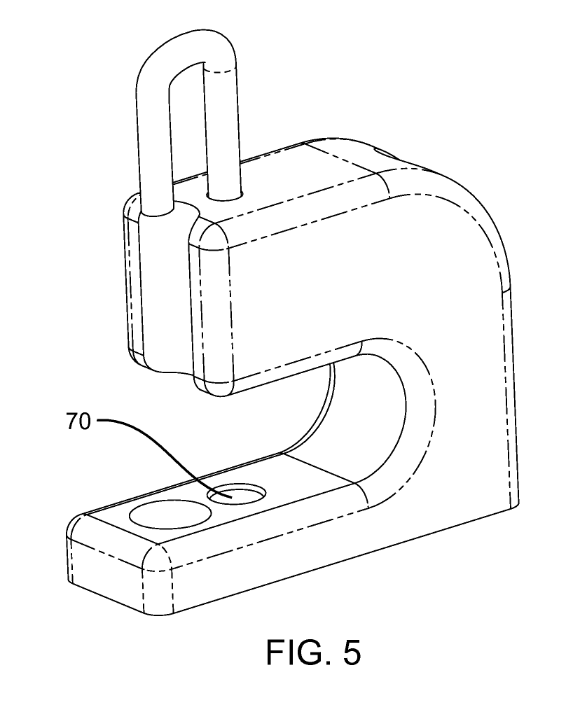

FIGS. 1, 3, 4 & 5 Illustrate elements of the present invention and the combination of elements as an assembly. The assembly comprises a C-shaped body 11 which is provided with mounting holes 18 so as to be affixed securely to a part of the sailing vessel, such as a spar, deck or any other solid surface (not shown). The body 11 is oriented with a flat base 56, with the channel 12 parallel to this base 56 and open from the aperture 14 to the outside of the body 11. The channel 12 and aperture 14 have a width which is slightly larger than the largest diameter line that the fairlead can accept. The body 11 has a vertical cavity 45 which is perpendicular to the channel 12 and base 11, wherein, the latch pin 23 is located. The latch pin 23 moves within this cavity 45, the centerline 55 of which is offset from the centerline of the aperture 62. The distance from the centerline 55 of the latch pin 23 to the centerline 62 of the aperture 14 is established so that the line (not shown) is able to be contained, and work, without restriction, in the aperture 14, as the latch pin 23 moves in and out of the channel 12. The latch pin 23 so provides the means to close and open the aperture 14. The latch pin 23 seats within a depression 70 in the bottom face of the channel 12 at closure of the aperture 14. This depression 70 is of the same diameter as the latch pin cavity 45 and provides for a locating surface to counter lateral forces that may be witnessed by the latch pin 23. If a lateral force is applied, the latch pin 23 acts upon the upper and lower portions of the body by its containment within the cavity 45 and lower depression 70. A pull pin 39 is affixed to the top of the latch pin 23 and extends through the top of the body 11. The pull pin 39 is bent to conform to the shape of the body 11 and to prevent snagging with extraneous lines, rigging or other objects (not shown). The pull pin 39 moves in direct relationship with the latch pin 23 and thusly provides the means to actuate the latch pin 23. The latching mechanism can be forced to close with a spring 17 but could also be free or magnetically latched (not shown).

Use of the present invention could generally be described wherein the sailor would lift the pull pin and thusly the latch pin, opening the channel to the aperture. The line could then be pulled laterally through the open channel and brought into the aperture. The sailor would then release the pull pin and capture the line in the fairlead. Release of the line from the fairlead is generally where the pull pin is used to lift the latch pin clear of the channel. The line is then pulled laterally from the aperture to the outside of the body and the pull pin is released. The orientation of the line in both the removal and engagement of the line is generally such that its centerline can be parallel to the centerline of the aperture.

What is claimed is:

1. A threadless fairlead assembly for receiving a line, said assembly comprising a C-shaped body having a channel which provides a gap from the outside of the body to the fairlead aperture, said fairlead having dimensions permitting said line to pass laterally through said channel and locate in said aperture while permitting said line to be relatively parallel to the centerline of said aperture.

2. The assembly of claim 1, wherein said dimensions are larger than the maximum diameter of the line engageable by the fairlead.

3. The assembly as in claim 1, wherein the assembly comprises a base for securement to a surface.

4. The assembly as in claim 1, wherein the centerline of the said aperture is generally parallel to base.

5. The assembly as in claim 1, wherein said channel is generally perpendicular to the centerline of said aperture.

6. The assembly as in claim 5, wherein said channel is generally parallel to said base.

7. A threadless fairlead assembly for receiving a line, said assembly comprising a C-shaped body having a channel which provides a gap from the outside of the body to the fairlead aperture, said fairlead having a latch pin and pull pin for capture of said line, said latch pin is located within a cavity in said body.

8. The assembly as in claim 7, wherein said latch pin moves generally within said cavity to provide opening and closure of said aperture.

9. The assembly as in claim 7, wherein centerline of said latch pin is generally perpendicular to centerline of said aperture.

10. The assembly as in claim 7, wherein centerline of said latch pin is offset from centerline of said aperture.

11. The assembly as in claim 7, wherein said latch pin locates in a depression in the bottom of said channel.

12. The assembly as in claim 10, wherein offset of said centerlines is dimensioned so as to allow for maximum diameter of said line engageable by the said fairlead.

13. The assembly as in claim 7, wherein said latch pin is connected to said pull pin.

14. The assembly as in claim 13, wherein said pull pin interpolates with said latch pin.

15. The assembly as in claim 7, wherein interpolation of said latch pin within said cavity closes and opens said aperture so as to allow for the extraction or insertion of said line, said line being able to generally maintain parallelism with said aperture centerline, as said line moves in and out of said fairlead assembly.
